(19) United States
(12) Patent Application Publication
(10) Pub. No.: US 2012/0288436 A1
(43) Pub. Date: Nov. 15, 2012

(54) APPARATUS AND METHOD FOR TREATING INCINERATION ASH USING PLASMA ARC

(75) Inventors: YOUNG SUK KIM, DAEJEON (KR); SOON MO HWANG, DAEJEON (KR); JIN HO LEE, DAEJEON (KR)

(73) Assignee: GS PLATECH CORPORATION, DAEJEON (KR)

(21) Appl. No.: 13/244,648

(22) Filed: Sep. 25, 2011

(30) Foreign Application Priority Data
May 12, 2011 (KR) 10-2011-0044594

(51) Int. Cl. C01F 11/28; B01D 17/00; B01J 8/00

(52) U.S. Cl. 423/497; 422/187; 422/285

(57) ABSTRACT

The present invention relates to an apparatus and a method for melting incineration ash generated in an incinerator using a steam plasma torch which is capable of minimizing secondary pollutants and collecting calcium chloride from the melt. An exemplary embodiment of the present invention provides a method for treating incineration ash, including: generating a melt by melting the incineration ash comprising fly ash and bottom ash using a steam plasma torch; cooling the melt using water to dissolve molten salt included in the melt in the water and vitrify slag included in the melt; and collecting calcium chloride from the water in which the molten salt is dissolved.

### CROSS-REFERENCE TO RELATED APPLICATION

This application claims priority from Korean Patent Application No. 10-2011-0044594 filed on May 12, 2011, the contents of all of which are incorporated herein by reference in their entirety.

### BACKGROUND

1. Technical Field

The present invention relates to an apparatus and a method for melting incineration ash generated in an incinerator using a steam plasma torch.

2. Description of the Related Art

Generally, melting equipment using fossil fuel such as coal, petroleum, natural gas, etc., is generally used for melting inorganic materials such as metal, non-metal, asbestos, incineration ash, radioactive waste, mold flux, glass, aluminum, sheath of arc torch, etc. However, the method using the fossil fuel melts the materials from the surface, therefore thermal efficiency is very low and it requires considerable energy for melting.

Incineration ash which is generated in a melting furnace can be distinguished into two types: bottom ash and fly ash. The bottom ash can be buried in the ground because it contains little toxic materials such as dioxin or heavy metal. However, the fly ash contains a great deal of dioxin and heavy metal so it causes secondary pollution when buried. For this reason, it is prohibited in Japan to bury the incineration fly ash and Korea is also considering the same policy.

The fly ash usually contains a considerable amount of calcium chloride. It is because semi-dry reactors are used for removing hydrogen chloride contained in exhaust gas which is generated in the incinerator. The calcium chloride causes contamination of cooling water because it is easily melted in the furnace and discharged with slag. It can also erode the furnace and therefore shorten the life span of the furnace. However, if the calcium chloride can be collected from the ash, it can be used for many purposes including de-icing roads in winter. In the usual plasma melting of ash nitrogen, argon or air is used for the plasma gas and the off-gas from the melter must be cleaned before they are released to the atmosphere. Using steam for the plasma gas greatly simplifies the cleaning process because by condensing steam the off-gas amount are remarkably reduced.

### SUMMARY

One or more embodiments of the present invention is to solve the above-mentioned problems, that is, to provide an apparatus and method for treating incineration ash including fly ash using plasma arc which is capable of minimizing secondary pollutants.

One or more embodiments of the present invention is also to provide an apparatus and method for treating incineration ash which is capable of collecting calcium chloride generated while treating the incineration ash.

One or more embodiments of the present invention is also to provide an apparatus and method for treating incineration ash using steam as a plasma gas.

An exemplary embodiment of the present invention provides a method for treating incineration ash, including: generating a melt by melting the incineration ash including fly ash and bottom ash using a steam plasma torch; cooling the melt by using water to dissolve molten salt included in the melt in the water and vitrify slag included in the melt; and collecting calcium chloride from the water in which the molten salt is dissolved.

The method may further include generating steam by using heat which is included in exhaust gas, the exhaust gas being generated while melting the incineration ash.

The method may further include feeding the generated steam into the steam plasma torch.

The method may further include supplying the generated steam as a heat source for collecting the calcium chloride.

The method may further include condensing and burning the exhaust gas.

An exemplary embodiment of the present invention provides an apparatus for treating incineration ash, including: a melting unit for generating a melt by melting the incineration ash comprising fly ash and bottom ash using a steam plasma torch; a water tank for cooling the melt using water to dissolve molten salt included in the melt in the water and vitrify slag included in the melt; and a CaCl₂ recovery unit for collecting calcium chloride from the water in which the molten salt is dissolved.

The melting unit may include a melting chamber for melting the incineration ash which is provided by an incineration ash provider; a supply tube formed on a side of the melting chamber, for feeding the incineration ash into the melting chamber; an exhaust gas outlet formed on the other side of the melting chamber, for discharging exhaust gas which is generated while the incineration ash is molten to the outside of the melting chamber; a separator wall arranged at a distance from the exhaust gas outlet and protrudes from an upper inner wall of the melting chamber; a discharger formed on the other side of the melting chamber, for discharging the melt; and a plasma torch module arranged penetrating through an upper side of the melting chamber between the supply tube and the separator wall and movable toward an inside of the melting chamber, for melting the incineration ash using a steam plasma torch.

The plasma torch module may operate the plasma torch in a non-transfer arc operating mode when a residue of the melt which is solidified at the bottom of the melting chamber exists, and convert the plasma torch into a transfer arc operating mode when the residue is molten.

The apparatus may further include a boiler for generating steam using heat included in the exhaust gas discharged through the exhaust gas outlet.

The steam generated by the boiler may be supplied to the plasma torch module.

The steam generated by the boiler may be supplied to the CaCl₂ recovery unit as a heat source for collecting the calcium chloride.

The exemplary apparatus may further include a condenser for condensing the exhaust gas.

The exemplary apparatus may further include a burner for burning CO which is included in the condensed exhaust gas.

In the exemplary apparatus, the water tank may include a main tank for dissolving the molten salt included in the melt discharged through the discharger in the water; and a subsidiary tank to which water contained in the main tank is transferred when a level of the water contained in the main tank is above a predetermined value, wherein the CaCl₂ recovery unit vaporizes water contained in the subsidiary water to collect the calcium chloride.

The exemplary apparatus may further include a cooler for maintaining the temperature of the water contained in the main tank within a predetermined level.

### BRIEF DESCRIPTION OF THE DRAWINGS

FIG. 1 illustrates an apparatus for treating incineration ash using plasma arc according to an example of the present invention.

FIG. 2 illustrates a melting unit shown in FIG. 1.

FIG. 3 illustrates a plasma torch module shown in FIG. 2.

FIGS. 4 and 5 is a flow diagram for describing the method for treating incineration ash according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and structures will be omitted for clarity and conciseness.

Hereinafter, examples of the present invention are described in detail referring to the drawings.

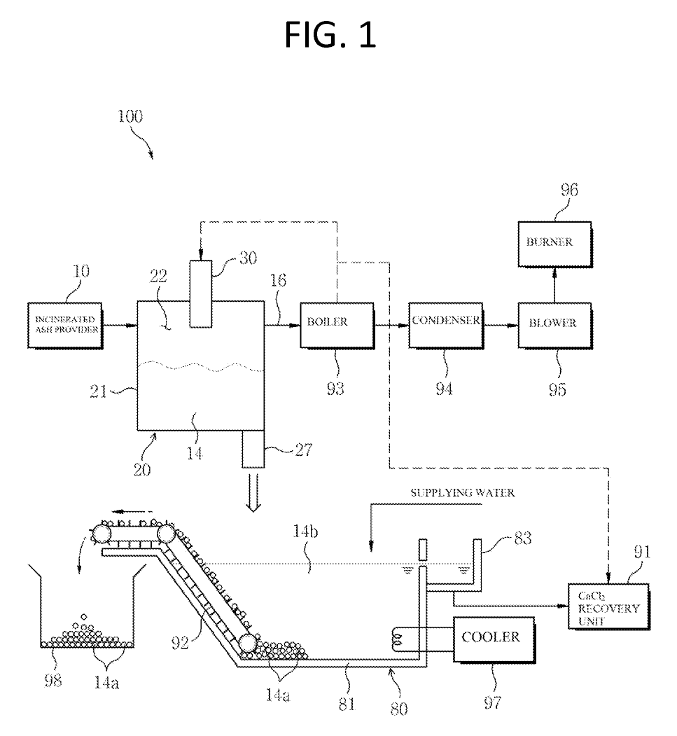

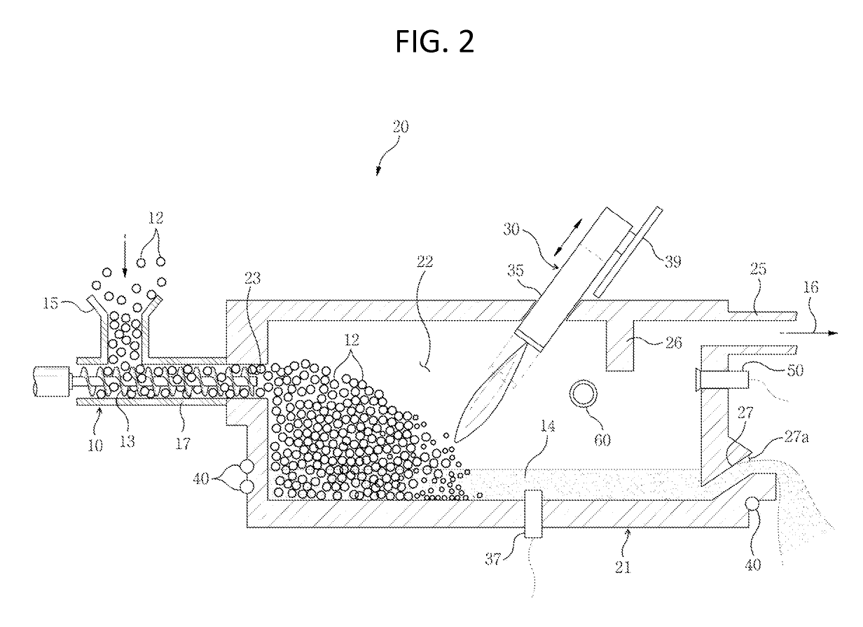

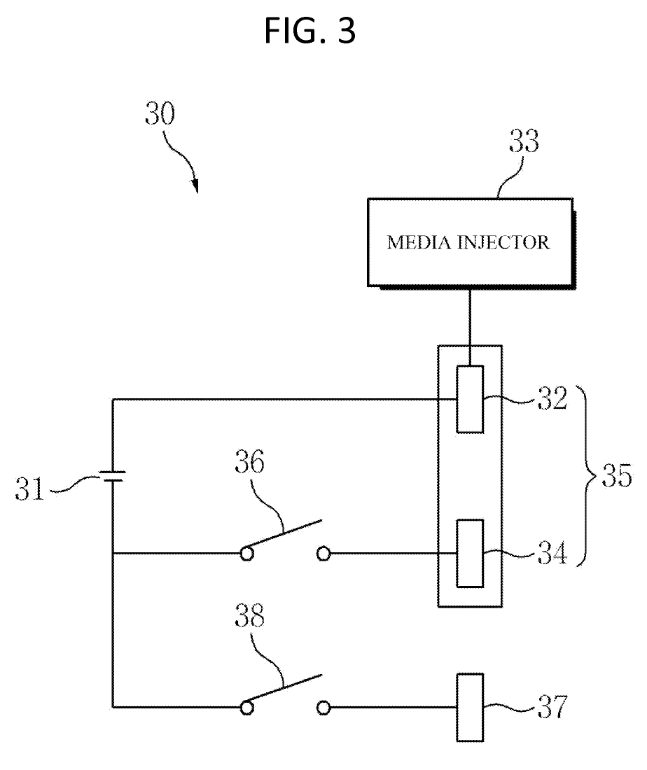

FIG. 1 illustrates an apparatus for treating incineration ash using plasma arc according to an example of the present invention. FIG. 2 illustrates a melting unit shown in FIG. 1. FIG. 3 illustrates a plasma torch module shown in FIG. 2.

Referring to FIGS. 1 to 3, an apparatus for treating incineration ash using plasma arc 100 includes an incineration ash provider 10 and a melting unit 20, and the apparatus 100 may further include a water tank 80 and a CaCl₂ recovery unit 91. The incineration ash provider 10 provides incineration ash 12 including fly ash and bottom ash to the melting unit 20. The melting unit 20 includes a melting furnace 21, and the melting furnace 21 generates a melt 14 by melting the incineration ash 12 which is provided by the incineration ash provider 10 using plasma arc. The water tank 80 contains water to which the melt 14 generated in the melting furnace 21 is supplied. Molten salt included in the melt 14 is dissolved in the water, and slag included in the melt 14 is vitrified. The CaCl₂ recovery unit 91 collects calcium chloride CaCl₂ from the molten salt-dissolved water 14b which is delivered from the water tank 80. The apparatus 100 may further include a conveyor 92, a boiler 93, a condenser 94, a blower 95, a burner 96, a cooler 97 and a slag collector 98.

The apparatus 100 for treating incineration ash using plasma arc according to an example of the present invention is described in detail below.

The incineration ash provider 10 provides incineration ash 12 to the melting furnace 21. The incineration ash 12 includes fly ash and bottom ash mixed in a certain ratio. The reason for mixing the bottom ash with the fly ash is to lower the melting point of the melt 14. In other words, it is possible to lower the melting point of the incineration ash 12 when the basicity of the incineration ash 12 is adjusted by mixing the bottom ash with the fly ash in appropriate rate. For example, the bottom ash can be mixed with the fly ash so that the melting point of the incineration ash 12 is lower than 1500° C. More particularly, for example, the bottom ash can be mixed with the fly ash in a ratio of 1:1.

Even if the bottom ash is mixed with the fly ash, the bottom ash does not affect the amount of generated calcium chloride compared with the input of only fly ash because most of the bottom ash is included in slag while melting. The incineration ash 12 can be provided in the form of a solid such as a powder or a granule. A screw feeder which supplies the incineration ash 12 to the melting furnace 21 using a screw can be used as the incineration ash provider 10. In this case, the incineration ash provider 10 may include a transferring tube 17, an inlet 15 and a screw blade 13. The transferring tube 17 is connected to a supply tube 23, and provides a path through which the incineration ash 12 can be transferred.

The inlet 15 is connected to the transferring tube 17 and supplies the incineration ash 12 into the transferring tube 17. The screw blade 13 is installed in the transferring tube 17 and transfers the supplied incineration ash 12 into the melting furnace 21 through the supply tube 23. The screw blade 13 rotates within the transferring tube 17 to move the incineration ash 12. Using the screw blade 13 to provide the incineration ash 12 into the melting furnace 21, it is possible to prevent high temperature gas which is generated while melting the incineration ash in the melting furnace from being leaked through the transferring tube 17 to the inlet 15. In other words, the high temperature gas does not leak through the transferring tube 17 because the transferring tube 17 is filled with the powdered or granular incineration ash 12.

When melting the incineration ash 12, the incineration ash provider 10 supplies the incineration ash 12 in such a way that the incineration ash 12 fills the supply tube 23 and covers an inside wall of a melting chamber 22 which is adjacent to the supply tube 23. It is for preventing the inside wall from being eroded by the melt 14.

The melting unit 20 melts the incineration ash by directly applying plasma arc to the incineration ash 12. The melting unit 20 includes a plasma torch module 30 including a plasma torch 35 that generates the plasma arc. Compared with the fossil fuel of the prior art, the temperature of the plasma arc is very high so that the heat can be directly transferred to the incineration ash 12 and the amount of the gas generated while melting can be reduced. Therefore, the melting unit 20 can melt the incineration ash 12 with high speed and efficiency.

The melting unit 20 includes a melting furnace 21 and a plasma torch module 30. The melting furnace 21 includes a supply tube 23, a melting chamber 22, an exhaust gas outlet 25, a separator wall 26 and a discharger 27. The supply tube 23 supplies the incineration ash 12 which is provided by the incineration ash provider 10. The melting chamber 22 is coupled to the supply tube 23 at one side of the melting chamber 22, and melts the incineration ash 12 which is provided by the supply tube 23. The exhaust gas outlet 25 is formed at the opposite side of the supply tube 23 and discharges exhaust gas 16 to the outside of the melting chamber 22. The separator wall 26 is arranged near the exhaust gas outlet 25 and protrudes from an upper inner wall of the melting chamber 22. The discharger 27 formed at the other side of the melting chamber 22 and discharges the melt 14. The plasma torch module 30 is arranged penetrating through an upper side of the melting chamber 22 between the supply tube 23 and the separator wall 26 and movable toward the inside of the melting chamber, and includes the plasma torch that applies the plasma arc to the piled up incineration ash 12 for melting the incineration ash 12. In addition, the melting unit 20 may further include a cooling jacket 40, a surveillance camera 50 and a temperature sensor 60.

In the melting furnace 21, the incineration ash 12 which is provided by the incineration ash provider 10 is melted. The melting chamber 22 includes an interior space which contains the piled up incineration ash 12 and the melt 14. The supply tube 23 protrudes outwardly from an upper part of the one side of the melting chamber 22. The exhaust gas outlet 25 is formed on the opposite side of the supply tube 23, and the separator wall 26 is formed between the supply tube 23 and the exhaust gas outlet 25.

The supply tube 23, the separator wall 26 and the exhaust gas outlet 25 are arranged as described above to prevent scattering dust from being leaked through the exhaust gas outlet 25 to the outside of the melting chamber 22.

The discharger 27 of the melting furnace 21 can be formed on the lower part of the other side of the melting chamber 22. An outlet 27a of the discharger 27 is formed above the bottom of the melting chamber 22. It is for preventing external air from being flowed into the inside of the melting chamber 22 through the outlet 27a, or internal gas from being leaked to the outside of the melting chamber 22 through the outlet 27a. Furthermore, the outlet 27a of the discharger 27 can be blocked using material such as dirt or ceramic, and the blocking material can be removed by external force or heat before discharging the melt 14. The melting furnace 21 can be operated under positive or negative pressure.

The elements included in the fly ash of the incineration ash 12 is Ca, Cl, Na, K, S, Zn, Si, Fe, Pb, Al, etc. in the order of their amount. Ca is included in the fly ash mostly in the form of Ca(OH)₂ or CaCl₂. Ca(OH)₂ is changed into CaO and included in the slag, and CaCl₂ is mostly included in molten salt. Na and K can be included in salt, slag or molten fly ash after being evaporated. S can be evaporated in the form of H₂S or H₂SO4, or can be included in the slag in the form of CaSO₄, depending on the oxidation/reduction atmosphere of the melting furnace 21. Most of Zn is evaporated, and most of Si, Fe and Al are included in the slag. Some of Pb is evaporated, and the rest is included in the slag. Most of CaCl₂ which occupies about 40 or 50% of the fly ash is separated from the slag in the melting furnace 21 and is included in the molten salt. Because the solubility of calcium chloride in water is 86.3 g/100 g, it is promptly dissolved in the water tank 80. As described above, because the poisonous heavy metals are evaporated in the melting furnace 21 or included in the slag, and because the solubility of CaS and CaSO₄ is very low, the water in the water tank 80 is not contaminated by the above-mentioned materials and it is possible to collect calcium chloride of high-purity. For example, it is possible to collect 400 kg to 500 kg of calcium chloride when treating 1 ton of fly ash.

The surveillance camera 50 is installed in the melting chamber 20 to keep watch on operations of the plasma torch 35 and melting status of the incineration ash 12, and captured images from the surveillance camera 50 is sent to an operating unit. In this case, the surveillance camera 50 can be installed higher than the surface of the melt 14. In the illustrated embodiment, the surveillance camera 50 is installed on the other side of the melting chamber 20 facing the one side of the melting chamber 20. However, the present invention is not limited to a specific position for installing the surveillance camera 50.

The temperature sensor 60 is installed in the melting chamber 20 to measure temperature in the melting chamber 20, and the measured temperature data are sent to the operating unit. In this case, the temperature sensor 60 can be installed higher than the surface of the melt 14.

The cooling jacket 40 is installed at the outer surroundings of lower part of the melting chamber 22 and around the discharger 27 and is used for cooling the refractory at the slag line of the melting chamber 22 and the discharger 27. The melt 14 in the melting chamber 22 may cause erosion of the inner wall of the melting chamber 22. So, when the cooling jacket 40 is arranged at the melting chamber 22 and the discharger 47 where the melt 14 is in contact, it is possible to prevent the inner refractory wall from being eroded. In other words, the melt 14 which is in contact with the melting chamber 22 and the discharger 27 is coagulated by the cooling jacket 40 and forms a kind of protective layer so that the inner wall can be protected from eroding because the melt 14 does not make direct contact with the inner wall. The cooling jacket 40 is connected to a heat exchanger and drops the temperature of the lower part of the melting chamber 22 and the discharger 27 using he refrigerant which is provided by the heat exchanger.

The plasma torch module 30 includes a power generator 31, a media injector 33, a plasma torch 35 and a torch moving device 39. The power generator 31 provides power for generating plasma arc to the plasma torch 35. The media injector 33 provides medium for generating plasma to the plasma torch 35. The plasma torch 35 generates plasma arc by generating arc discharge using the medium which is provided by the media injector 33. The torch moving device 39 moves the plasma torch forward to or backward from the bottom of the melting chamber 22.

The media injector 33 can provide steam as the medium for the plasma torch 35. Air or nitrogen can also be used as the medium, however, it is inappropriate to use the air or nitrogen because pollutants such as NOₓ are generated.

The plasma torch 35 may be a transferred type plasma torch including a rear electrode 32 and a front electrode 34, and an electrode 37 is installed at the bottom of the melting chamber 22 for discharging the arc directly on the incineration ash 12. The rear electrode 32 is positively biased with the power generator 31. The front electrode is arranged at the front of the rear electrode 32, and negatively biased via a first switch 36. The electrode 37 is negatively biased via a second switch 38.

When the positive charge is applied to the rear electrode 32 and the negative charge is applied to the front electrode 34, the arc is generated on the plasma torch 35. In this case, the plasma torch 35 is operated in a non-transfer mode, and the arc is generated inside the plasma torch 35 and discharged outwardly.

When the incineration ash 12 is melted and the melt 14 gets conductive, the switch 36 is cut off, the negative charge is applied to the electrode 37 and the positive charge is applied to the rear electrode 32. Then, the arc moves from the plasma torch 35 to the melt 14. In this case, the plasma torch 35 is operated in a transfer mode, and the arc is generated on the melt 14.

The plasma torch 35 is arranged at a certain distance from the incineration ash 12 which is provided through the supply tube 23 and is piled up in the melting chamber 22. It is preferable to arrange the plasma torch 35 to aim at the interface of the piled up incineration ash 12 and the melt surface so that the incineration ash 12 can be melted quickly. In other words, the plasma torch can be arranged at a certain angle with respect to the bottom surface of the melting chamber 22.

For example, the incineration ash 12 can be melted as described below using the plasma torch 35 according to an embodiment of the present invention. At first, there can be some residue of the melt 14 which is solidified at the bottom of the melting chamber 22. Because the solidified residue is not conductive, the plasma torch 35 is operated in a non-transfer arc operating mode first for melting the residue. In this case, the torch moving device 39 moves the plasma torch 35 toward the bottom of the melting chamber 22.

When the solidified residue is melted and gets conductive, the plasma torch 35 converts its operating mode to the transfer arc operating mode for melting the incineration ash 12. In this case, the torch moving device 39 moves the plasma torch 35 apart from the bottom of the melting chamber 22. When the plasma torch 35 is operated in the transfer arc operating mode, and the operating voltage of the plasma torch 35 is increased, a heat loss can be reduced. In this case, the melting speed of the incineration ash 12 can be easily controlled by adjusting current applied to the plasma torch 35. The plasma torch 35 can be operated in a mixed operating mode which uses both the non-transfer and the transfer arc operating modes after the plasma torch 35 is moved away from the bottom of the melting chamber 22.

For example, assuming 5 bar pressure steam is needed for operating the plasma torch 35, the maximum amount of steam which is needed for the plasma torch 35 may be 2,000 Lpm/1 MW, that is, 100 Kg/h/1 MW. In this case, if the capacity of the boiler 93 is about 1 ton/h, the boiler 93 can provide enough steam for operating the plasma torch 35.

The water tank 80 is arranged under the discharger 27 of the melting furnace 21 and receives the melt 14 from the discharger 27. The water tank 80 includes a main tank 81 and a subsidiary tank 83 coupled with the main tank 81. The melt 14 which is discharged from the melting chamber 22 is poured into the main tank 81. The main tank 81 contains water, and the amount of the water supplied to the main tank 81 is determined corresponding to the amount the molten salt-dissolved water 14b which is supplied to the CaCl₂ recovery unit 91. The melt 14 includes molten salt and slag, among them the molten salt is dissolved in the water, and the slag is cooled and vitrified by the water.

The cooler 97 circulates cooling water in the water tank 80 for maintaining of the water contained in the water tank 80 within a predetermined level. The cooler 97 may minimize the amount of the cooling water to maximize the solubility of the molten salt in the water while keeping in the range for vitrifying the slag. The cooler 97 may include a circulation coil inserted into the water tank 80 so that the cooling water flows in the circulation coil. In the illustrated example, the circulation coil is inserted into the water tank 80. However, it is possible to include additional circulation coils inserted in an inner wall of the water tank 80. For example, a wall of the water tank 80 may have a double jacket structure and the circulation coil can be installed between the inner and outer wall of the water tank 80.

The conveyor 92 is coupled to the main tank 81 and transfers the vitrified slag 14a to the outside of the main tank 81. The conveyor 92 can be installed obliquely at one side of the main tank 81 for stably transferring the slag 14a. One side of the conveyor 92 can be arranged near the bottom of the main tank 81, and the other side of the conveyor 92 can be exposed to the outside of the main tank 81. A slag collector 98 can be installed at the other side of the conveyor 92 for collecting the slag 14a. The slag 14a which is collected in the slag collector 98 can be recycled for industrial use.

The CaCl₂ recovery unit 91 receives the molten salt-dissolved water 14b from the subsidiary tank 83. The CaCl₂ recovery unit 91 produces calcium chloride from the molten salt-dissolved water 14b. The CaCl₂ recovery unit 91 of an embodiment of the present invention evaporates the water using heat provided by the boiler 93 to produce the calcium chloride. The vacuum evaporation method can be used for reducing the amount of steam required for the producing of the calcium chloride.

For example, if the melting unit 20 can treat 1 ton of the incineration ash 12 per hour, yield of the calcium chloride is 0.5 ton/hour and 0.6 ton of water is needed for dissolving the produced calcium chloride. Although the amount of steam needed for evaporating the water is theoretically similar to the amount for dissolving the calcium chloride, 0.85 ton/hour of steam is actually needed for evaporating, assuming that the evaporation efficiency is 70%. The amount of steam needed for evaporation can be supplied by the boiler 93, so that the CaCl₂ recovery unit 91 needs no additional energy for evaporating the water.

The boiler 93 is coupled to the exhaust gas outlet 25 for receiving the exhaust gas 16. The boiler 93 supplies generated steam to the plasma torch module 30 and the CaCl₂ recovery unit 91. For example, the temperature of the exhaust gas 16 is about 1,400° C. when discharged from the melting furnace 21. The discharged exhaust gas 16 is cooled while passing through the boiler 93 to the temperature of 180° C. The boiler 93 supplies the cooled exhaust gas 16 to the condenser 94.

The condenser 94 receives the exhaust gas 93 from the boiler and condenses it. The condenser 94 includes a cooling tower and a washing tower, and the volume of the exhaust gas is significantly reduced when passed through the cooling tower and the washing tower. Toxic materials included in the exhaust gas are also eliminated while condensing the exhaust gas. Waste water generated while condensing the exhaust gas is sent to a waste water treatment facility. It is possible to apply evaporation method for treating the waste water because the amount of the waste water is only about 100 L/h. The steam generated by the boiler 93 can be used for evaporating the waste water.

The blower 95 blows the exhaust gas which is condensed by the condenser 94 to the direction of the burner 96. The amount of the condensed exhaust gas is very little so it is possible to use a compact sized blower 95. The condensed exhaust gas can be directly discharged to the outside of the apparatus 100 if the exhaust gas does not contain combustible gas.

The burner 96 burns CO included in the exhaust gas which is provided from the blower 95 and discharges to the outside of the apparatus 100. If the exhaust gas includes combustible materials, they can be burned while passed through the burner 96. Because the toxic materials are eliminated by the condenser 94, it is possible to discharge the exhaust gas after burning. A thermal oxidizer can be used for the burner 96.

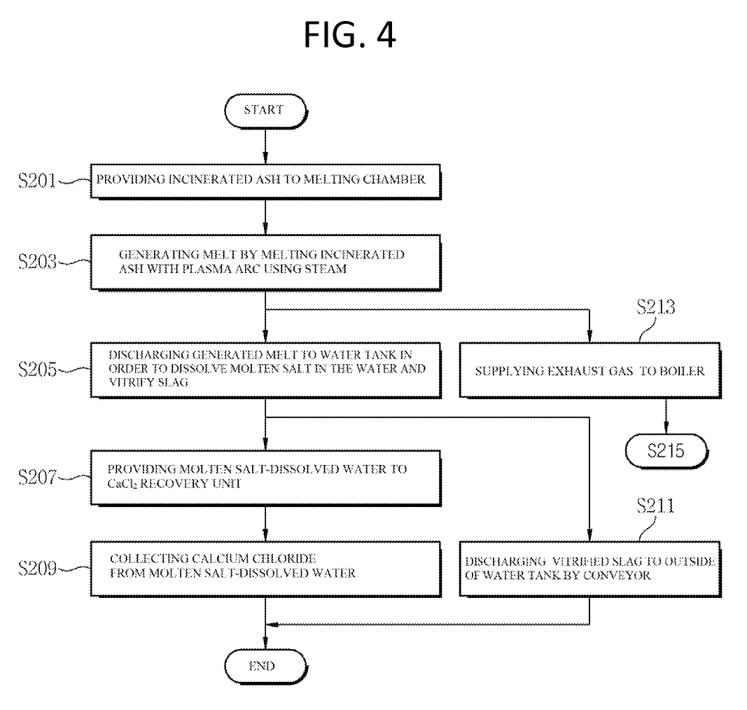

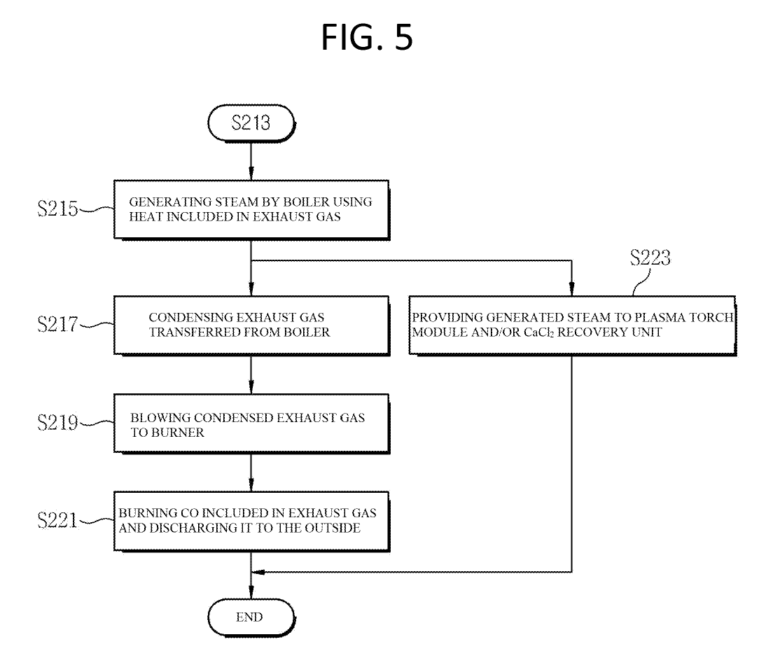

A method for treating incineration ash using the apparatus 100 of an embodiment of the present invention is described below referring FIGS. 1 through 5. FIGS. 4 and 5 is a flow diagram for describing the method for treating incineration ash according to an embodiment of the present invention.

In step S201, the incineration ash provider 10 provides incineration ash 12 to the melting chamber 22 of the melting furnace 21. In this step, the incineration ash provider 10 supplies enough amount of the incineration ash 12 so that the incineration ash 12 fills the supply tube 23 and covers an inside wall of a melting chamber 22 which is adjacent to the supply tube 23.

The outlet 27a of the discharger 27 is blocked using material such as dirt or ceramic or wool. It is for preventing high temperature gas or heat which is generated by the arc discharge from being leaked to the outside of the melting chamber 22 through the outlet 27a.

Next, in step S203, the plasma torch module 30 generates melt 14 by melting the incineration ash 12 using plasma arc.

The step S203 is more specifically described as follows. At first, the torch moving device 39 moves the plasma torch 35 towards the bottom of the melting chamber 22. Next, the plasma torch module 30 operates the plasma torch 35 in a non-transfer arc operating mode, and melts residue of the melt 14 which has been solidified at the bottom of the melting chamber 22. There can be some residue of the melt 14 which has been melted and solidified at the bottom of the melting chamber 22. Because the solidified residue is not conductive, the plasma torch 35 cannot be operated in a non-transfer arc operating mode. In this case, the plasma torch 35 is operated in a non-transfer arc operating mode for melting the residue or the incineration ash 12. In the non-transfer arc operating mode, a negative charge is applied to the front electrode 34 and a positive charge is applied to the rear electrode 32.

When the solidified residue is melted and gets conductive, the plasma torch 35 converts its operating mode to the transfer arc operating mode for melting the incineration ash 12. In this case, the torch moving device 39 moves the plasma torch 35 apart from the bottom of the melting chamber 22. When the plasma torch 35 is operated in the transfer arc operating mode, and the operating voltage of the plasma torch 35 is increased, a heat loss can be reduced. The power generator 31 opens the first switch 36 to cut off applying the negative charge to the front electrode 34 and closes the second switch 38 to apply the negative charge to the electrode 37.

As described above, when the arc is discharged at the melt 14, it is possible to melt the incineration ash 12 quickly because the temperature of the plasma arc is very high, and the heat is directly delivered to the incineration ash 12.

The exhaust gas generated while melting the incineration ash 12 is discharged through the exhaust gas outlet 25. Because the separator wall 26 is formed in front of the exhaust gas outlet 25, it is possible to prevent scattering dust from being carried over through the exhaust gas outlet 25 to the outside of the melting chamber 22. In other words, it is possible to minimize carry-over of the scattering dust because the scattering dust is blocked by the separator wall 26 and rotates in the melting chamber 22.

Also, because the cooling jacket 40 is coupled with the heat exchanger and circulates the refrigerant through the outer surroundings of lower part of the melting chamber 22 and the discharger 27, it is possible to prevent the inner wall of the melting chamber 22 and the discharger 27 from being eroded by the melt 14.

Next, in step S205, the melting furnace 21 discharges the generated melt 14 to the water tank 80. When the level of the melt 14 in the melting chamber 22 is higher than the level of the outlet 27a of the discharger 27, the blocking material which blocks the outlet 27a is removed and the melt 14 is discharged. Because the outlet 27a of the discharger 27 is formed above the bottom of the melting chamber 22, it is possible to prevent external air from being flowed into the inside of the melting chamber 22 through the outlet 27a, or internal gas from being leaked to the outside of the melting chamber 22 through the outlet 27a. The melt 14 which is discharged from the melting chamber 22 is poured into the main tank 81, the molten salt included in the melt 14 is dissolved in the water and the slag included in the melt 14 is cooled and vitrified.

The temperature of the water tank 80 is controlled by circulation of the cooling water using the cooler 97. The cooler 97 may minimize the amount of the cooling water to maximize the solubility of the molten salt in the water.

Next, in step S207, the molten salt-dissolved water 14b is provided to the CaCl₂ recovery unit 91. When the level of the water contained in the main tank 81 is above a predetermined value, the water is moved to the subsidiary tank 83. The water contained in the subsidiary tank 83 is supplied to the CaCl₂ recovery unit 91. The water contained in the subsidiary tank 83 can be transferred to the CaCl₂ recovery unit 91 when solubility of the molten salt-dissolved water 14b is approaching its maximum level. In an embodiment of the present embodiment, the CaCl₂ recovery unit 91 receives the molten salt-dissolved water 14b from the subsidiary tank 83, but it is also possible for the CaCl₂ recovery unit 91 to receive the molten salt-dissolved water 14b directly from the main tank 81.

Next, in step S209, the CaCl₂ recovery unit 91 collects calcium chloride from the molten salt-dissolved water 14b. The CaCl₂ recovery unit 91 can collect calcium chloride by evaporating water using steam which is provided by the boiler 93. A vacuum evaporation method can be used for reducing the required amount of the steam in the step S209.

Next, in step S211, the slag 14a is transferred to the outside of the water tank 80 by conveyor 92. The slag collector collects the discharged slag 14a.

Exhaust gas 16 which is generated in the melting chamber 22 is supplied to the boiler 93.

Next, in step S215, the boiler 93 generates steam using heat which is included in the exhaust gas 16. The temperature of the exhaust gas 16 is about 1,400° C. when discharged from the melting furnace 21 and dropped to 180° C. while passing through the boiler 93. The boiler 93 supplies the cooled exhaust gas 16 to the condenser 94.

Next, in step S217, the condenser 94 receives the exhaust gas 93 from the boiler and condenses it. The condenser 94 includes a cooling tower and a washing tower, and the volume of the exhaust gas is significantly reduced when passed through the cooling tower and the washing tower. Toxic components which are included in the exhaust gas are also eliminated while condensing the exhaust gas.

Next, in step S219, the blower 95 blows the exhaust gas which is condensed by the condenser 94 to the direction of the burner 96. The condensed exhaust gas can be directly discharged to the outside of the apparatus 100 if the exhaust gas doesn't contain the toxic or combustible components.

And, in step S221, the burner 96 burns CO included in the exhaust gas which is provided from the blower 95 and discharges to the outside of the apparatus 100. If the ash includes combustible components, the exhaust gas may include considerable amount of CO. In this case, the CO can be burned while passed through the burner 96.

In step S223, the steam which is generated in the step S215 is provided to, for example, the plasma torch module 30 and/or the CaCl₂ recovery unit 91.

According to the embodiments of the present invention, it is possible to minimize secondary pollutants while treating incineration ash because the incineration ash is melted by using a steam plasma torch. When the incineration ash is melted by using plasma arc which is generated with the use of steam, the amount of the secondary pollutants such as NOₓ can be reduced.

The embodiments of the present invention is also capable of melting the incineration ash more rapidly compared with the prior art using fossil fuel because the present invention uses steam plasma torch for melting the incineration ash.

Because steam used for the steam plasma torch is easily obtained from the melting process without an extra facility, and the specific heat at constant pressure is greater than other gases used for plasma torch, it is possible to make a large plasma torch which has good thermal efficiency and high operating voltage.

According to the embodiments of the present invention, it is possible to reduce the amount of the exhaust gas because steam can be collected in the form of condensate using a cooling tower and a washing tower. Furthermore, according to the embodiments of the present invention, it is possible to collect calcium chloride with high purity by dissolving the melt in the water and evaporating it.

Furthermore, in the embodiments of the present invention, an exhaust gas outlet is formed on the other side from a supply tube, and a separator wall is arranged between the exhaust gas outlet and the place where the incineration ash is melted, so that it is possible to prevent the scattering dust from being leaked through the exhaust gas outlet.

Furthermore, because the volume of the exhaust gas is greatly reduced when passed through the cooling tower and the washing tower, it is possible to reduce the amount of the exhaust gas which is discharged in the air. Moreover, the CO which is included in the exhaust gas is burned before discharged, it is possible to discharge the exhaust gas with little secondary pollutant and minimize the pollution caused by the exhaust gas.

Furthermore, the embodiment of the present invention is capable of minimizing the energy waste and cost for generating steam which is used for generating plasma arc and evaporating the calcium chloride because the heat included in the exhaust gas is used for generating the steam.

While the invention has been described in terms of what is presently considered to be the most practical and preferred embodiments, it is to be understood that the invention needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for treating incineration ash, comprising:
generating melt comprising molten salt and slag by melting the incineration ash comprising fly ash and bottom ash with the use of a steam plasma torch;
cooling the melt by using water to dissolve the molten salt in the water and vitrify the slag; and
collecting calcium chloride from the water in which the molten salt is dissolved.

2. The method of claim 1, further comprising generating steam using heat which is included in exhaust gas, the exhaust gas being generated while melting the incineration ash.

3. The method of claim 2, further comprising feeding the generated steam into the steam plasma torch.

4. The method of claim 2, further comprising supplying the generated steam as a heat source for collecting the calcium chloride.

5. The method of claim 2, further comprising condensing the exhaust gas, thus considerably reducing the amount of off-gas, and burning the exhaust gas.

6. The method of claim 1, wherein the steam plasma torch is operated in a non-transfer arc operating mode when there is a residue of the melt which is solidified, and the steam plasma torch is operated in a transfer arc operating mode when the residue of the melt is molten.

7. An apparatus for treating incineration ash, comprising:
a melting unit for generating melt comprising molten salt and slag by melting the incineration ash comprising fly ash and bottom ash with the use of a steam plasma torch;
a water tank for cooling the melt by using water to dissolve molten salt in the water and vitrify the slag; and
a CaCl₂ recovery unit for collecting calcium chloride from the water in which the molten salt is dissolved.

8. The apparatus of claim 7, wherein the melting unit comprises:
an incineration ash provider to provide the incineration ash;
a melting chamber for melting the incineration ash which is provided by the incineration ash provider;
a supply tube formed on a side of the melting chamber to feed the incineration ash into the melting chamber;
an exhaust gas outlet formed on the other side of the melting chamber to discharge exhaust gas which is generated while the incineration ash is being molten to the outside of the melting chamber;
a separator wall arranged at a distance from the exhaust gas outlet and protrudes from an upper inner wall of the melting chamber;
a discharger formed on the other side of the melting chamber to discharge the melt; and
a plasma torch module mounted in an upper side of the melting chamber between the supply tube and the separator wall and movable toward an inside of the melting chamber to melt the incineration ash by using the steam plasma torch.

9. The apparatus of claim 8, wherein the plasma torch module operates the plasma torch in a non-transfer arc operating mode when a residue of the melt which is solidified at the bottom of the melting chamber exists, and converts the plasma torch into a transfer arc operating mode when the residue is molten.

10. The apparatus of claim 8 further comprising a boiler for generating steam by using heat included in the exhaust gas discharged through the exhaust gas outlet.

11. The apparatus of claim 10, wherein the steam generated by the boiler is supplied to the plasma torch module.

12. The apparatus of claim 10, wherein the steam generated by the boiler is supplied to the CaCl₂ recovery unit as a heat source for collecting the calcium chloride.

13. The apparatus of claim 10, further comprising a condenser for condensing the exhaust gas.

14. The apparatus of claim 13, further comprising a burner for burning CO which is included in the condensed exhaust gas.

15. The apparatus of claim 8, wherein the water tank comprises:
a main tank for dissolving the molten salt discharged through the discharger in the water; and
a subsidiary tank to which water contained in the main tank is transferred when a level of the water contained in the main tank is above a predetermined value,
wherein the CaCl₂ recovery unit vaporizes water contained in the subsidiary water to collect the calcium chloride.

16. The apparatus of claim 15, further comprising a cooler for maintaining the temperature of the water contained in the main tank within a predetermined level.
